(19) United States
(12) Patent Application Publication
(10) Pub. No.: US 2021/0252505 A1
(43) Pub. Date: Aug. 19, 2021

(54) PATTERNED MICROFLUIDIC DEVICES AND METHODS FOR MANUFACTURING THE SAME

(71) Applicant: CORNING INCORPORATED, CORNING, NY (US)

(72) Inventors: Donald Erwin Allen, Painted Post, NY (US); Ye Fang, Painted Post, NY (US); Jeffrey Glenn Lynn, Wellsboro, PA (US); Barry James Paddock, Horseheads, NY (US)

(21) Appl. No.: 17/251,010

(22) PCT Filed: Jun. 10, 2019
(86) PCT No.: PCT/US2019/036269

§ 371 Date: Dec. 10, 2020

Related U.S. Application Data
(60) Provisional application No. 62/685,100, filed on Jun. 14, 2018.

(51) Int. Cl. B01L 3/00

(52) U.S. Cl. CPC B01L 3/502707; B01L 2200/12; B01L 2300/0896; B01L 2300/0887; B01L 2300/0829

(57) ABSTRACT

A process of manufacturing a microfluidic device (200, 201, 202, 300, 301, 302, 400, 401, 402) includes the steps of attaching a monolayer of polymer beads onto a first substrate (210, 410) depositing a metal oxide film onto the first substrate (210, 410) over the monolayer of polymer beads, and removing the polymer beads to form an array of metal oxide nano-wells (240, 440) wherein the first substrate (210, 410) is exposed at the bottom of the nano-wells (240, 440). The process also includes depositing an organophosphate layer onto the metal oxide film. The process also calls for depositing a silane coating layer or an acrylate polymer onto the exposed first substrate (210, 410). The method further includes bonding a second substrate (220, 420) to the first substrate (210, 410) to enclose the array of metal oxide nano-wells (240, 440) in a cavity within the first and second substrates (210, 220, 410, 420).

### CROSS-REFERENCE TO RELATED APPLICATIONS

This application claims the benefit of priority under 35 U.S.C. § 119 of U.S. Provisional Application No. 62/685,100, filed Jun. 14, 2018, the content of which is incorporated herein by reference in its entirety.

### FIELD

The present disclosure generally relates to patterned microfluidic devices and methods of manufacturing patterned microfluidic devices for biomolecular analysis, and in particular, gene sequencing.

### BACKGROUND

Biological samples are often complicated in composition and amount. Analysis of biomolecules in a biological sample often involves the partition of a single sample into tens of thousands or millions samples for quantitative determination. This is often achieved using a solid substrate surface to selectively immobilize and partition different biomolecules in the biological sample.

Microfluidic devices have found wide applications in biomolecular analysis, mostly driven by the ability of microfluidics to spatially and/or temporally control bio-reactions, which is critical to many biomolecular analyses. For instance, for optical-detection-based massively parallel gene sequencing techniques (also termed next-generation sequencing, NGS), millions of short DNA fragments generated from a genomic DNA sample can be captured and partitioned onto a patterned surface of a microfluidic device such that these DNA fragments are spatially separated from each other to facilitate sequencing by, for example, synthesis, ligation, or single-molecule real-time imaging. These gene sequencing techniques can be used to sequence entire genome, or small portions of the genome such as the exome or a preselected subset of genes.

Embodiments of the present disclosure represent an advancement over the state of the art with respect to microfluidic devices and methods of making the same. These and other advantages, as well as additional inventive features, will be apparent from the description provided herein.

### SUMMARY

Embodiments of the present disclosure provide a microfluidic device that contains patterned nano-wells on an etched channel floor surface for gene sequencing applications. Certain embodiments disclosed herein include a manufacturing process for making microfluidic devices that contain patterned nano-wells on an etched channel floor surface, as well as a process for using microfluidic devices, that contain patterned nano-wells on an etched channel floor surface, for gene sequencing applications.

In some embodiments, the microfluidic devices include selective surface chemistry coating of microfluidic devices that contain patterned nano-wells on an etched channel floor surface, where the interstitial wall of the nano-wells is made of metal oxide and coated with organophosphate molecules that are resistant to binding with DNA, proteins, and/or nucleotides, and the bottom surface of the nano-wells is made of SiO₂ (silicon dioxide) or glass and coated with silane molecules that promote binding with DNA, proteins, and/or nucleotides via either electrostatic interaction or covalent bonds.

In some embodiments, a process of manufacturing a microfluidic device includes the steps of etching a first substrate to form at least one channel, attaching a monolayer of polymer beads onto the first substrate, reducing the size of the polymer beads using plasma etching, depositing a metal oxide film onto the first substrate over the monolayer of polymer beads, and removing the polymer beads to form an array of metal oxide nano-wells, wherein the first substrate is exposed at the bottom of the nano-wells. The process also can include depositing an organophosphate layer onto the metal oxide film, the organophosphate configured to be resistant to binding with DNA, proteins, and/or nucleotides. The method also can include depositing a silane coating layer or an acrylate polymer onto the exposed first substrate at the bottom of the nano-wells, and bonding a second substrate to the first substrate to enclose the array of metal oxide nano-wells in a cavity within the first and second substrates. The term “cavity,” as used herein, refers to the three-dimensional space bounded by the interior surfaces of the first and second substrates after bonding, while “channel” refers either to the sometimes U-shaped floor created in the first and/or second substrates, or to the individually-addressable channels formed in the aforementioned substrate floor.

In some embodiments, the method includes dispensing a solution containing the polymer beads into liquid over the submerged substrate, and transferring the polymer beads in a monolayer onto the substrate. The method may optionally include heating the substrate to cause the polymer beads to attach to the substrate, and subsequently exposing the polymer beads to oxygen plasma to reduce the size of the polymer beads. The method may further include removing the polymer beads from the substrate. For example, the polymer beads can be removed using sonication in a solvent solution such as ethanol or other solvents. Additionally, or alternatively, the polymer beads can be removed using chemical or enzymatic digestion or degradation (e.g., when the polymer beads are made of a degradable or biodegradable polymer such as polygalacturonic acid (PGA)). For example, beads made of PGA can be size reduced by plasma, and can be removed from the surface using pectinase, a plant enzyme.

In some embodiments, the method includes depositing an organophosphate layer that is one of a polyethylene glycol-containing organophosphate and/or polyvinyl phosphoric acid, (e.g., in embodiments in which the side-wall of the nano-wells formed is metal oxide). Additionally, or alternatively, the method includes depositing an organophosphate layer that is one of an amine-terminated organophosphate, epoxy-terminated organophosphate, carboxylate organophosphate, and/or an organophosphate derivative containing an unsaturated moiety such as cycloalkene, cycloalkyne, heterocycloalkene, or heterocycloalkyne (e.g., in embodiments in which the bottoms of the nano-wells are metal oxide). Further, the method may include depositing one of amine-terminated silane, epoxy-terminated silane, carboxylate-terminated silane, thiol-terminated silane, and/or a silane derivative containing an unsaturated moiety such as cycloalkene, cycloalkyne, heterocycloalkene, or heterocycloalkyne onto the exposed first substrate at the bottoms of the nano-wells, (e.g., in embodiments in which the bottoms of the nano-wells are silicon dioxide or glass). Additionally, or alternatively, the method may include depositing one of hydroxyl-terminated silane, and/or polyethylene glycol silane, (e.g., in embodiments in which the side-walls of the nano-wells are silicon dioxide).

In some embodiments, a DNA primer is covalently or otherwise bonded to the bottom of one or more nano-wells. The aforementioned polymer beads may be made from polystyrene or a similar material such as polyester, polypropylene, biodegradable polymer (e.g., polygalacturonic acid (PGA)), or another suitable material. In some embodiments, each of the polymer beads has a diameter from 0.05 micrometer to 5 micrometers. In some embodiments, the average center-to-center distance between adjacent nano-wells is from 0.05 micrometer to 5 micrometers. The substrates may include one or more individually-addressed channels in which the polymer beads are attached.

The bonding of the first and second substrates may be performed using one of a glue, a UV-curable glue, polymer tape, and pressure-sensitive tape. In alternate embodiments, bonding of the first and second substrates can be performed using laser-assisted bonding wherein a bonding layer (e.g., of metal or metal oxide) is inserted between the first and second substrates. In some embodiments, a negative charge is imparted to the polymer beads such as carboxylate-presenting polystyrene beads, and a positive charge to the substrate such as 3-aminopropyltriethoxylsilane coated glass substrate.

In some embodiments, a microfluidic device includes a first substrate with a first patterned array of nano-wells on a first interior surface and having a side wall with an end surface. In some of such embodiments, a second substrate has a second interior surface and a peripheral surface portion, and the end surface of the first substrate is bonded to the peripheral surface portion of the second substrate, such that the first and second interior surfaces define a cavity within the bonded first and second substrates.

In some embodiments, the second substrate has a second patterned array of nano-wells on the second interior surface. In some of such embodiments, the first patterned array of nano-wells or the second patterned array of nano-wells may be disposed within one or more channels in the first or second interior surface. In some embodiments, the depth of the one or more channels is from 30 micrometers (μm) to 500 micrometers (μm).

In some embodiments, the microfluidic device includes an inlet at one end of the first or second substrate, and an outlet at another end of the first or second substrate opposite the first end. The thickness of the metal oxide film may be in a range from one nanometer (nm) to 500 nanometers (nm). In certain embodiments, the metal oxide film is transparent to light with wavelengths in a range from 400 nanometers (nm) to 750 nanometers (nm).

In some embodiments, a process of manufacturing a microfluidic device includes the steps of etching a first substrate to form at least one channel, depositing a metal oxide layer onto the first substrate, attaching a monolayer of polymer beads onto the first substrate, reducing the size of the polymer beads using plasma etching, depositing a silicon dioxide film onto the first substrate over the monolayer of polymer beads, and removing the polymer beads to form an array of silicon dioxide nano-wells, wherein the metal oxide layer of the first substrate is exposed at the bottom of the nano-wells. The process also can include depositing an organophosphate layer onto the metal oxide bottom of the nano-wells, the organophosphate configured to promote the binding with DNA, proteins, and/or nucleotides. In some embodiments, the method includes depositing a silane coating layer onto the silicon dioxide side wall of the nano-wells, the silane coating configured to resist to the binding with DNA, proteins, and/or nucleotides. In some embodiments, the method includes bonding a second substrate to the first substrate to enclose the array of silicon dioxide nano-wells in a cavity within the first and second substrates.

In some embodiments, a microfluidic device includes a first substrate and an array of metal oxide or silicon dioxide nano-wells disposed on the first substrate. The first substrate can be exposed at bottoms of the nano-wells. A second substrate can be bonded to the first substrate, whereby the array of metal oxide or silicon dioxide nano-wells is enclosed in a cavity between the first and second substrates.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

The accompanying drawings incorporated in and forming a part of the specification illustrate several aspects of the present disclosure. In the drawings:

FIG. 1 is a schematic drawing showing a patterned microfluidic device, constructed in accordance with exemplary embodiments;

FIGS. 2A, 2B and 2C are schematic drawings showing a side view along the channel direction of three one-sided patterned microfluidic devices, wherein the top and bottom substrates are bound together differently, in accordance with exemplary embodiments;

FIGS. 3A, 3B and 3C are schematic drawings showing a side view along the channel direction of three two-sided patterned microfluidic devices, wherein the top and bottom substrates are bound together differently, in accordance with exemplary embodiments different from those shown in FIGS. 2A, 2B and 2C;

FIGS. 4A, 4B and 4C are schematic drawings showing a side view along the channel direction of three two-sided patterned microfluidic devices, wherein the top and bottom substrates are bound together differently, in accordance with exemplary embodiments different from those shown in FIGS. 2A, 2B and 2C and those shown in FIGS. 3A, 3B and 3C;

FIG. 5 is a flow chart illustrating the process used to make patterned microfluidic devices using nanosphere lithography, according to exemplary embodiments;

FIGS. 6A-6E are illustrations of exemplary scanning electron microscope images, showing closely packed polystyrene beads on a channel floor surface of a channeled glass slide, which show the effects of oxygen plasma treatment for different time periods;

FIG. 7 is a graphical representation of the diameters of the polystyrene beads as a function of oxygen plasma ashing duration;

FIG. 8 is an exemplary scanning electron microscope image showing metal oxide nano-wells after stripping off the closely packed polystyrene beads; and

FIG. 9 shows a fluorescence microscopic image of Cy3-dT30 after being hybridized to the dA30 molecules covalently attached to the bottom surfaces of the nano-wells.

While certain preferred embodiments will be disclosed hereinbelow, there is no intent to be limited to those embodiments. On the contrary, the intent is to cover all alternatives, modifications and equivalents as included within the spirit and scope of the disclosure as defined by the appended claims.

### DETAILED DESCRIPTION

Embodiments of the present disclosure are related to patterning surfaces using nanosphere lithography and, more specifically, to directly patterning the surface of microfluidic channels. Nanosphere lithography can be used to generate periodic surface nano-texturing on large area substrates such as flat glass wafers and glass sheets. In some embodiments, nanosphere lithography can be applied to make nano-patterning inside deep microfluidic channels.

Applicants have determined that patterning the surface of a solid substrate may be an effective means to selectively capture and thus partition biomolecules of interest in a biological sample. Photolithography and nanoimprinting methods may enable high throughput and high fidelity in making patterns including nano-patterning. However, such processes may be limited in the geometry of the solid substrate to be patterned. For example, photolithography may be useful for patterning flat wafer substrates (e.g., glass, pure silica, and silicon), while nanoimprinting may be useful for patterning flat or curved wafer substrates. However, it may be difficult to implement these methods for making nano-patterning inside a microfluidic channel.

Some embodiments of the disclosure described hereinbelow include microfluidic devices that contain patterned nano-wells on an etched channel floor surface, and methods of manufacturing patterned microfluidic devices for biomolecular analysis and, in particular, gene sequencing. The patterned microfluidic devices may contain one or more channels, e.g., multiple individually-addressed channels.

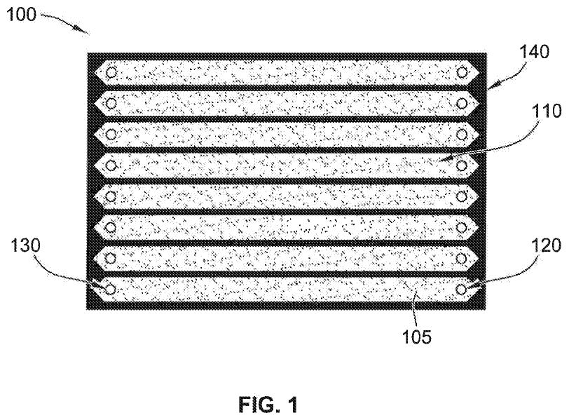

FIG. 1 is a schematic drawing showing some embodiments of a patterned microfluidic device 100 comprising eight individually-addressed channels 105. In some embodiments, on at least one channel surface of each channel 105, there are patterned nano-wells 110. In some embodiments, the patterned microfluidic device 100 comprises an inlet port 120, and an outlet port 130 for each channel 105. The black region 140 shows the area where the first (top) and second (bottom) substrates are joined or bound together to form a seal (e.g., via a bonding layer). In some embodiments, the seal is hermetic.

The channels 105 and inlet/outlet ports 120, 130 can be made on a first (top) substrate or on a second (bottom) substrate. The first substrate can be glass, glass ceramics, silica, or another suitable material, while the second substrate can be glass, glass ceramics, silicon, silica, or another suitable material. The first substrate and/or the second substrate can be transparent within the wavelength range between 400 nm and 750 nm. The patterned nano-wells 110 can be made of metal oxide, silicon dioxide, or another suitable material. For example, the patterned nano-wells can be defined within a film comprising a metal oxide, silicon dioxide, or another suitable material disposed on a first substrate and/or a second substrate (e.g., using nanosphere lithography) as described herein. The metal oxide or silicon dioxide can be deposited at a temperature below the glass transition temperature Tg of polymer microbeads used for nanosphere lithography. The metal oxide can be (e.g., can comprise one or more of) Al₂O₃, ZnO₂, Ta₂O₅, Nb₂O₅, SnO₂, MgO, indium tin oxide, CeO₂, CoO, Co₃O₄, Cr₂O₃, Fe₂O₃, Fe₃O₄, In₂O₃, Mn₂O₃, NiO, a-TiO₂ (anatase), r-TiO₂ (rutile), WO₃, Y₂O₃, ZrO₂, other metal oxides, or combinations thereof. In some embodiments, the metal oxide is transparent to light within a visible wavelength (e.g., from 400 nm to 750 nm).

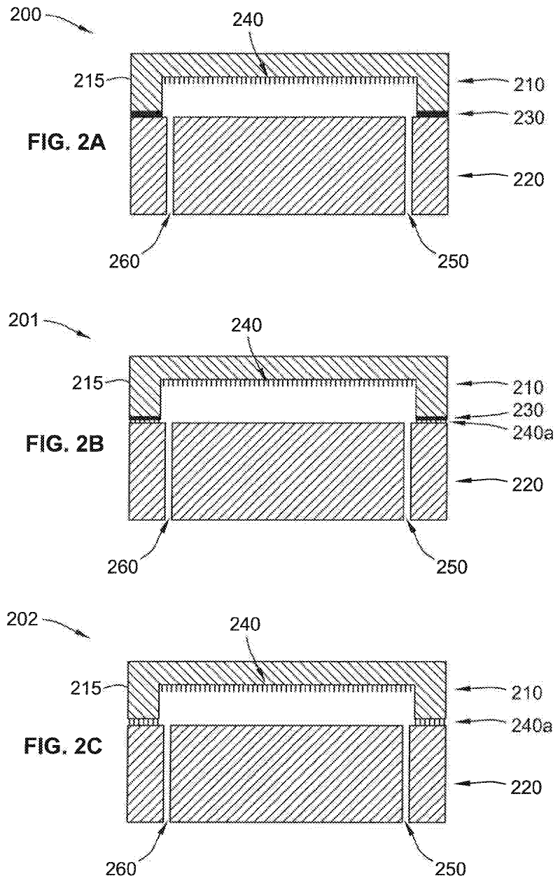

FIGS. 2A, 2B and 2C are schematic drawings showing a side view along the channel direction of three exemplary one-sided patterned microfluidic devices 200, 201, 202, wherein the one-sided patterned microfluidic devices 200, 201, 202 include a first or top substrate 210 and a second or bottom substrate 220, where, in each of the three embodiments, the top and bottom substrates 210, 220 are joined together using different mechanisms.

In the embodiments shown, the one-sided patterned microfluidic devices 200, 201, 202 include patterned nano-wells 240 on a channel floor (e.g., an etched channel floor) surface of the first or top substrate. For example, the top substrate 210 can be first chemically etched to form a channel, and the patterned nano-wells 240 can be formed on the channel floor surface via nanosphere lithography. In some of such embodiments, the bottom substrate 220 is flat and includes two openings from the exterior surface to the interior surface of the bottom substrate 220, one as an inlet port 250 and another as an outlet port 260. The inlet and outlet ports 250, 260 can provide fluidic movement pathways for the microfluidic devices 200, 201, 202. The fluidic movement pathway defines the direction and path of a biological sample passing through a microfluidic device. Specifically, a biological sample can be loaded into a channel of a microfluidic device through its inlet port by a physical force (e.g., pumping). Once loaded, the biological sample can fill up the entire space of the microfluidic channel and come into contact with the top channel floor and bottom surfaces, until the biological sample reaches the outlet port and further exits out of the device. Gene sequencing can include many cycles of reads, each including multiple fluidic exchanges (e.g., nucleotide addition, terminator cleavage, buffer washing).

In some embodiments shown in FIG. 2A, the one-sided patterned microfluidic device 200, the top and bottom substrates 210, 220 are bound together directly via the bonding layer 230 disposed between the top and bottom substrates 210, 220. For example, the bonding layer 230 is disposed on the end surface of the sidewall 215 for the etched channel of the first substrate 210. In some embodiments, the bonding layer 230 includes a metal. For example, the metal may be (e.g., comprise) one or more of gold, chromium, titanium, nickel, copper, zinc, cerium, lead, iron, vanadium, manganese, magnesium, germanium, aluminum, tantalum, niobium, tin, indium, cobalt, tungsten, ytterbium, zirconium, or an appropriate combination, or an oxide thereof. An appropriate combination includes a known alloy of these metals, or metal oxide, for instance, indium tin oxide or indium zinc oxide.

In some embodiments, the bonding layer 230 is first patterned on the top substrate 210, followed by protection (e.g., with photoresist or an etchant-resistant polymer tape). After chemical etching, a channel can be formed on the top substrate 210. After nanosphere lithography, patterned nano-well arrays 240 can be formed inside the channel including the channel floor surface. Finally, the protection (e.g., photoresist or polymer tape) can be removed to expose the bonding layer 230. The bonding of the top patterned substrate and the flat bottom substrates 210, 220 can be achieved using a laser-assisted radiation bonding process. In some embodiments, the bonds can be laser bonds, for example, as described in U.S. Pat. Nos. 9,492,990, 9,515,286, and/or 9,120,287, the entirety of which are incorporated herein by reference.

In some embodiments, the bonding layer 230 can comprise a glue, a UV-curable glue, a polymer-carbon black composite film, a double sided pressure adhesive tape, or a double sided polyimide tape. The top substrate 210 can be first partially protected with a photoresist, an ink, or an etchant resistant polymer tape. After chemical etching of the non-protected area to form the channel, nanosphere lithography can be used to form patterned nano-well arrays 240 on the channel floor surface or on individually-addressable channels 105 (see FIG. 1). Finally, the protection photoresist, ink, or polymer tape can be removed. The bonding layer 230 then can be deposited or placed onto the protected areas of the top substrate 210 (e.g., the end surface of the sidewall 215 of the channel of the first substrate 210). The bonding of the top and bottom substrates 210, 220 can be achieved by pressure (e.g., when the bonding layer is tape), by UV crosslinking (e.g., when the bonding layer 230 is UV-curable glue), or by another suitable process.

In some embodiments shown in FIG. 2B, the one-sided patterned microfluidic device 201, the top substrate 210 includes a metal bonding layer 230 on the non-etched end surface and also includes patterned nano-wells 240 on the entire interior surface including the end surface areas and the channel floor surface, while the bottom substrate is flat. In some embodiments, the top substrate 210 is coated with the metal bonding layer 230. After etching to form a channel, and following nanosphere lithography, a patterned oxide layer 240a can be disposed on the end surface of the side wall 215 of the channel, beside the channel floor surface. Thus, the metal bonding layer 230 and the patterned oxide layer 240a above it can serve together to bond the top substrate 210 to the bottom substrate 220.

In some embodiments shown in FIG. 2C, the one-sided patterned microfluidic device 202, the top substrate 210 includes patterned nano-wells 240 on its entire interior surface including the end surface areas and the channel floor surface (as opposed to individually-addressed channels 105 as shown in FIG. 1), while the bottom substrate 220 is flat. The bonding of the top and bottom substrates 210, 220 can be achieved via patterned nano-wells 240a made of a metal oxide layer. The patterned nano-wells 240a may be on the end surface of the channel side wall 215 that is in close contact with the bottom substrate 220.

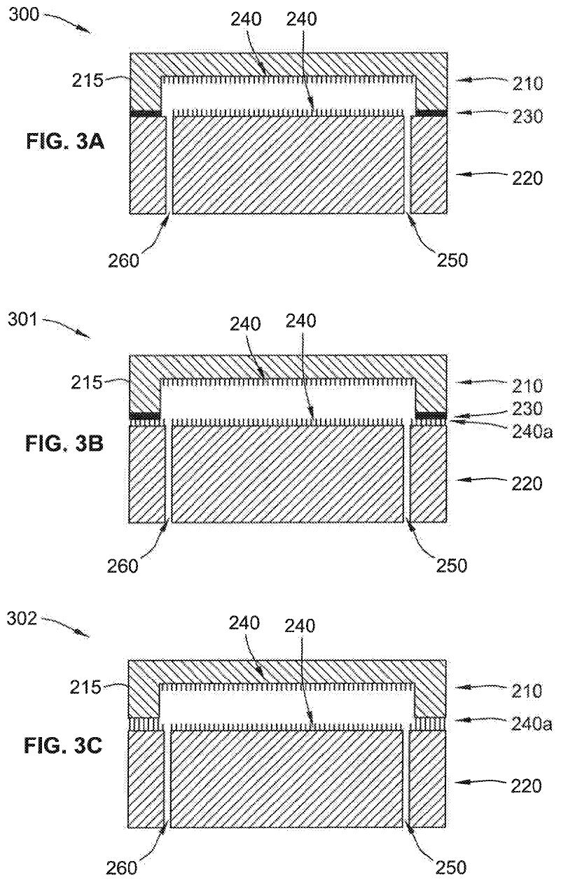

FIGS. 3A, 3B and 3C are schematic drawings showing a side view along the channel direction of three exemplary two-sided patterned microfluidic device 300, 301, 302 in which the top 210 and bottom substrates 220, in each of the three embodiments, are bound together differently. In some of the embodiments shown, the first or top substrate 210 includes patterned nano-wells 240 on an etched channel floor surface, and the second or bottom substrate 220 is flat and includes patterned nano-wells 240 on its entire interior surface.

In some embodiments shown in FIG. 3A, there is a two-sided patterned microfluidic device 300. The top substrate 210 can include a channel floor having patterned nano-wells 240 and a side wall 215 with an end surface including the bonding layer 230. The bottom substrate 220 can be flat and include patterned nano-wells 240 below the opening of the channel of the top substrate 210. The bottom substrate 220 can have a peripheral surface area below the bonding layer 230 of the top substrate 210. The bottom substrate 220 also can include the inlet port 250 and the outlet port 260. The inlet and outlet ports 250, 260 can provide fluidic movement pathways for the microfluidic devices 300, 301, 302. The bonding of the top and bottom substrates 210, 220 can be achieved via the bonding layer 230.

In some embodiments shown in FIG. 3B, there is a two-sided patterned microfluidic device 301. The top substrate 210 can include a metal bonding layer 230 on the non-etched area of the end surface of the channel side wall 215, and patterned nano-wells 240 on the channel floor surface. The bottom substrate 220 can be flat and include patterned nano-wells 240 on its entire interior surface. The bonding of the top and bottom substrates 210, 220 can be achieved via the metal bonding layer 230 of the top substrate 210 in contact with the metal-oxide-layer-containing patterned nano-wells 240a of the bottom substrate 220.

In some embodiments shown in FIG. 3C, there is a two-sided patterned microfluidic device 302, in which both the top and bottom substrates 210, 220 include patterned nano-wells 240 on their entire interior surfaces. The bonding of the top and bottom substrates 210, 220 can be achieved via the two metal oxide layers, each including patterned nano-wells 240a that are in close contact with each other.

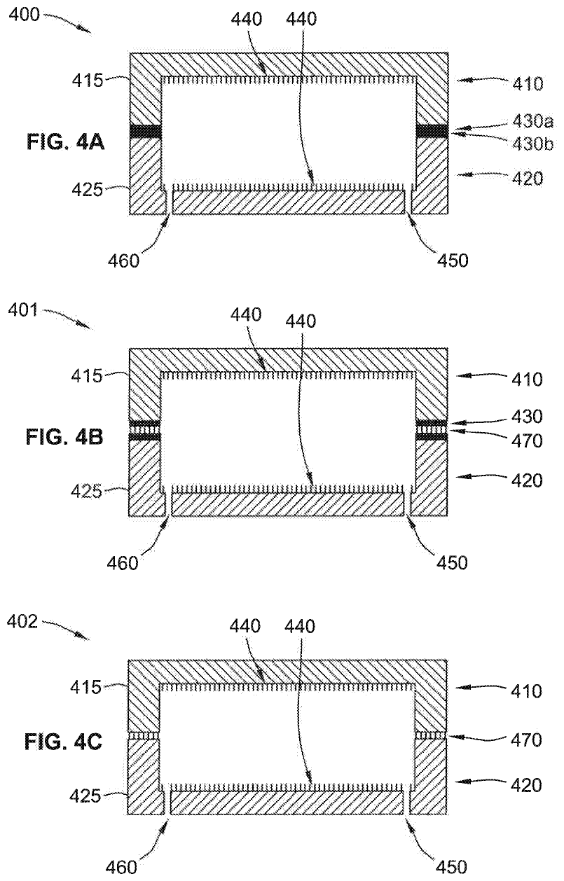

FIGS. 4A, 4B and 4C are schematic drawings showing a side view along the channel direction of three exemplary two-sided patterned microfluidic devices 400, 401, 402, where, in each of the three embodiments, the top and bottom substrates 410, 420 are bound together differently. In some of the embodiments shown, both top and bottom substrates 410, 420 include etched channels and patterned nano-wells 440 on their etched channel floor surfaces. The two substrates 410, 420 can be identical or different in composition and thickness.

In some embodiments shown in FIG. 4A, there is a two-sided patterned microfluidic device 400 in which each of the top substrate 410 and the bottom substrate 420 includes a channel having patterned nano-wells 440 and respective side walls 415, 425 including bonding layers 430a and 430b, respectively. The bottom substrate 420 also can include an inlet port 450 and an outlet port 460. The inlet and outlet ports 450, 460 can provide fluidic movement pathways for the microfluidic devices 400, 401, 402. The bonding of the top and bottom substrates 410, 420 can be achieved via the two bonding layers 430a and 430b.

In some embodiments shown in FIG. 4B, the two-sided patterned microfluidic device 401 is configured such that each of the top 410 and bottom 420 substrates includes a metal bonding layer 430 on its non-etched areas on the end surfaces of its respective side walls, 415, 425, and further includes patterned nano-wells 440 on its entire interior surface. The bonding of the top and bottom substrates 410, 420 can be achieved via the two metal bonding layers 430 and their top patterned nano-well regions 470.

In some embodiments shown in FIG. 4C, the two-sided patterned microfluidic device 402 is configured such that each of the top and bottom substrates 410, 420 includes patterned nano-wells 440 on its entire interior surface. The bonding of the top and bottom substrates 410, 420 can be achieved via the two metal oxide layers 470, each having patterned nano-wells on the mating side wall end surfaces that are in close contact each other.

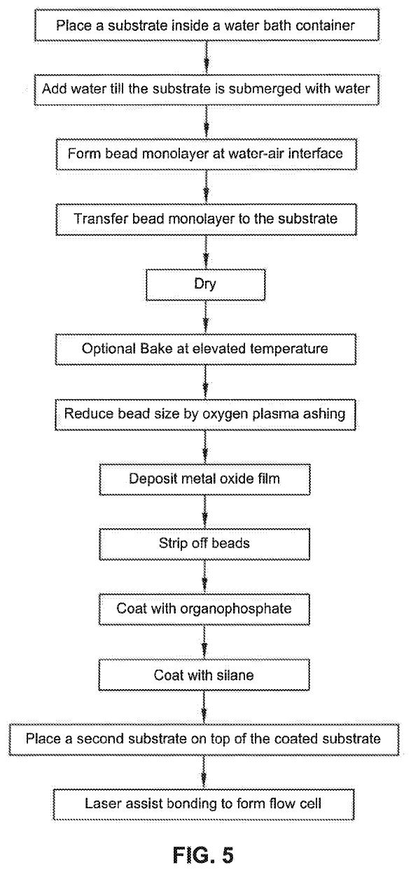

Embodiments of the present disclosure also include a method of making nano-patterned wells on a substrate with or without a channel In some embodiments, the method includes a modified Langmuir-Blodgett-film-type transfer approach. In some embodiments, as shown in FIG. 5, the method includes the steps of: providing a water bath container containing a substrate holder frame and a water drain pipe below the frame; placing a first substrate on top of the substrate holder frame; adding water until the first substrate is submerged with water; dispensing a solution including polymer beads in an organic solvent into the water bath container until a polymer bead monolayer is formed at the water-air interface; draining the water using the water drain pipe to transfer the polymer bead monolayer to the first substrate; drying the first substrate including the polymer bead monolayer; optionally baking the first substrate at an elevated temperature to strengthen the attachment of the polymer beads with the first substrate; reducing the polymer bead size (e.g., applying oxygen plasma to reduce the polymer bead size); optionally baking the substrate at an elevated temperature to strengthen the attachment of the polymer beads with the first substrate; depositing metal oxide or silicon dioxide film onto the first substrate; stripping off the polymer beads to form patterned nano-wells on the first substrate (e.g., nano-wells comprising voids remaining within the deposited metal oxide or silicon dioxide film following stripping off of the polymer beads); placing a second substrate on top of the patterned first substrate; and bonding the second substrate to the first substrate (e.g., by performing laser assist bonding) to form the microfluidic device.

In some embodiments, the method comprises coating the channel interior surfaces of the microfluidic device with a material that enables binding with DNA, proteins, and/or nucleotides to the patterned nano-wells. In some embodiments, the first substrate includes an etched channel before performing nanosphere lithography. In some embodiments, the first substrate includes an etched channel that is further coated with a metal oxide before performing nanosphere lithography. Depending on applications, the resultant nano-wells can have one of the following four possible configurations: bare substrate bottom/SiO₂ side wall, bare substrate bottom/metal oxide side wall, metal oxide bottom/SiO₂ side wall, or metal oxide bottom/metal oxide side wall. The coating can be one of an organophosphate, a silane, or both, depending on the nano-well configurations and applications. For instance, when the nano-wells formed are metal oxide bottom/SiO₂ side wall, an organophosphate that enables binding with DNA, proteins or nucleotides first can be applied to coat the metal oxide bottom, and a silane such as polyethylene glycol silane that is resistant to binding with DNA, proteins, and/or nucleotides then can be used to coat the SiO₂ side walls.

The substrate can be a slide, a wafer, a glass sheet, or another suitable configuration. For example, the wafer can be a standard 6 inch wafer, 8 inch wafer, 12 inch wafer, or a square wafer. In some embodiments, the substrate can be flat, or contain etched channels. The dimension of patterned nano-wells on the substrate can be defined by the size of polymer beads before and after the oxygen plasma treatment. The pitch, or center-to-center distance between adjacent nano-wells of patterned nano-wells on the substrate can be defined by the original size of polymer beads. For example, when 1 μm polymer beads are used, the pitch can be about 1 μm. The diameter of the patterned nano-wells can be defined by the size of polymer beads after the oxygen plasma treatment. For example, when the polymer bead size is reduced to 0.5 μm from 1 μm, the diameter of the metal oxide wells can be about 0.5 μm. The depth of the metal oxide or silicon dioxide wells can be defined by the thickness of metal oxide or silicon dioxide film deposited. For example, when a 50 nanometer (nm) layer of metal oxide is deposited, the depth of the metal oxide nano-wells formed can be about 50 nm. In some embodiments, the diameter of the patterned nano-wells obtained using such nanosphere lithography can be further reduced by depositing a layer of metal or silicon oxide film over the entire surface of the patterned substrate using, for example, atomic layer deposition, e-beam deposition, plasma-enhanced chemical vapor deposition, or other approaches.

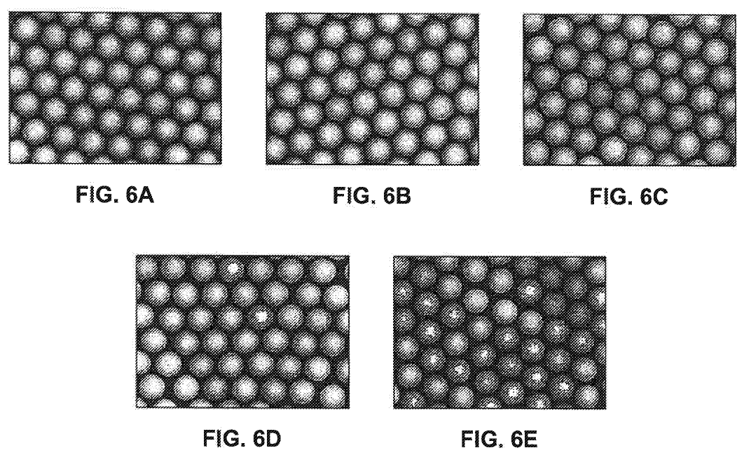

In some embodiments, oxygen plasma treatment is used to reduce the size of polymer beads. Additionally, or alternatively, argon plasma or other suitable processes can be used to reduce the size of polymer beads. In some embodiments, the size reduction is controlled by three parameters: plasma power, gas flow rate, and/or plasma treatment duration. For instance, in some embodiments shown in FIG. 6A, using the modified Langmuir-Blodgett film transfer approach, a monolayer of 600 nm polystyrene nano-beads was formed inside channels of a 1×3-inch slide. The slide included 8 individually-addressable channels, each having a width of 2.38 mm, a length of 70 mm and a channel depth of 100 μm. After treatment with oxygen plasma (e.g., exposing the polystyrene beads to the oxygen plasma) for different times, the size of polystyrene beads was reduced uniformly and gradually over the plasma treatment duration (see FIGS. 6A-6E).

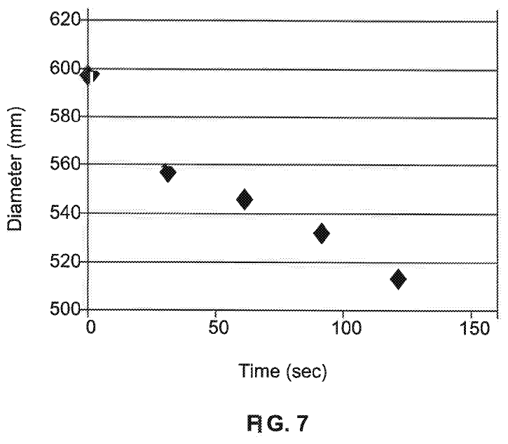

As the plasma treatment duration increased, the polymer bead size was continuously reduced. FIG. 7 shows a graphical representation of the reduction in bead size as a function of plasma treatment duration under 200 W power at 15 mTorr, and 40 (SCCM) oxygen. SCCM is Standard Cubic Centimeters per Minute, a flow measurement term indicating cm³/min in standard conditions for temperature and pressure of the gas.

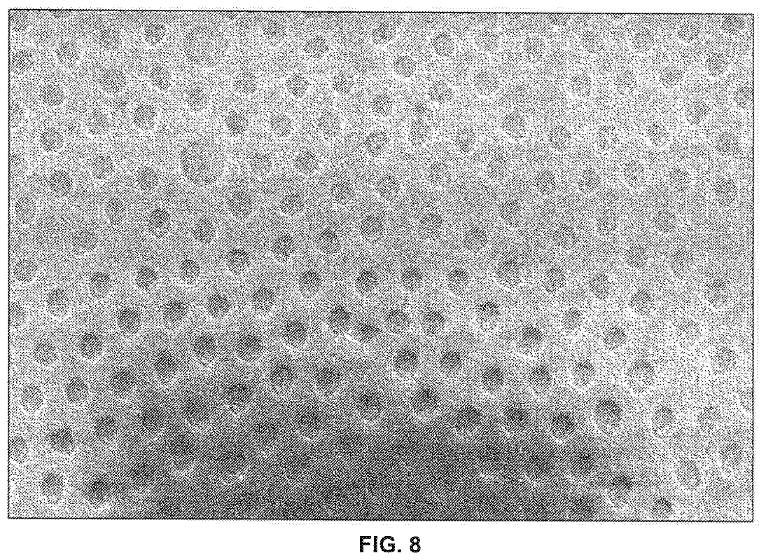

FIG. 8 shows representative scanning electron microscopic (SEM) image of some embodiments of a patterned metal oxide nano-wells inside a channel. For example, a monolayer of 1 μm polystyrene microbeads was transferred to a 1×3-inch glass substrate including 8 individually-addressable channels 105 (e.g., as shown in FIG. 1), each channel 105 having a width of 2.38 mm, a length of 70 mm and a channel depth of 100 μm. An optional bake was performed at 120° C. for 30 seconds to strengthen the attachment of the polystyrene beads with the glass surface. The substrate and its monolayer of polystyrene beads was then treated with oxygen plasma for 300 seconds at 200 Watts, 15 mTorr, 40 SCCM oxygen. Afterward, the substrate was baked again at 120° C. for 30 seconds to strengthen the attachment of the polystyrene beads to the glass substrate surface. This was followed by deposition of a 50 nm Al₂O₃ (aluminum oxide) layer to form an array of metal oxide nano-wells on the substrate surface. Finally, the polymer beads were stripped off using sonication in ethanol solution. The SEM image of FIG. 8 shows that the channel floor surface of the glass substrate includes an array of Al₂O₃ nano-wells with relatively high uniformity. In some instances, a small percentage of the nano-wells formed can be larger than expected. Without wishing to be bound by any theory, it is believed that such larger than expected nano-wells may result from the starting polystyrene beads having a larger size. While a majority of the nano-wells formed had uniform distance between them (e.g., uniform pitch), a minority of nano-wells were separated farther (e.g., larger than expected pitch). Without wishing to be bound by any theory, it is believed that such larger separation may result from randomly-occurring differences in bead size and/or bead spacing. In some embodiments, these randomly-occurring features (e.g., empty or large sized nano-wells) can act as a location registration or identification mark for imaging and follow-up data analysis processes (e.g., fiducials). Additionally, or alternatively, a physical mark (e.g., line, square, or circular features) can be introduced during film deposition or post film deposition step using, for instance, a laser direct writing approach, and used as the location registration or identification mark (e.g., fiducial).

Although some embodiments described in reference to FIGS. 5-7 include polymer beads made of polystyrene, other embodiments are included in this disclosure. For example, in some embodiments, the polymer beads comprise a degradable (e.g., biodegradable) polymer (e.g., polygalacturonic acid (PGA)). In some of such embodiments, the polymer beads can be size reduced as described herein in reference to polystyrene beads (e.g., plasma treatment). Additionally, or alternatively, the polymer beads can be removed using chemical or enzymatic degradation or digestion (e.g., using pectinase, a plant enzyme). In various embodiments, the beads can be made of a variety of materials (e.g., polymeric or otherwise) that can be size reduced and removed from the substrate to form the nano-wells as described herein.

In some embodiments, a monolayer of polymer beads can be formed by pulling a substrate out of a concentrated, well dispersed polymer bead suspension solution after incubation for a certain period of time. In some of such embodiments, the polymer beads can have a negative charge, for instance, carboxylated polystyrene beads; while the substrate can have a positive charge, for instance, the substrate has an aminopropylsilane coating. The electrostatic interaction between the polymer beads and the substrate can enhance the attachment of polymer beads with the substrate surface. Such interaction may result in relatively random distribution of beads on the substrate. By controlling the bead concentration, the solvent, incubation time, pulling rate or the interaction between the beads and the substrate surface, it is possible to form a monolayer of polymer beads on the substrate surface that is well separated and evenly distributed. When this occurs, the plasm treatment may be omitted, and the resulting bead-coated substrate can be directly subjected to oxide film deposition, and the nano-wells can be formed after stripping off the beads.

In some embodiments, the monolayer of polymer beads can be formed on the substrate surface by spin coating of a concentrated, well dispersed polymer bead suspension solution.

The present disclosure also discloses a selective surface chemistry coating of microfluidic devices that include patterned nano-wells on an etched channel floor surface, where the interstitial wall of the nano-wells is made of metal oxide and coated with organophosphate molecules that are resistant to binding with DNA, proteins, and/or nucleotides, and the bottom surface of the nano-wells is made of SiO₂ or glass and coated with silane molecules that permit binding to DNA, proteins, and/or nucleotides via either electrostatic interaction or covalent bonds.

The silane molecule used can be aminopropylsilane or the like (e.g., when DNA is DNA nanoballs and attached to the silane coated regions with electrostatic interactions). The silane molecule used can be epoxysilane (e.g., when DNA has an amine terminal so covalent bond can be formed). The silane molecule used can be an aminosilane (e.g., when DNA has an amine terminal and a bifunctional linker molecule (e.g., BS3, or a polymer containing anhydride moieties) is used to covalently couple the DNA to the aminosilane coated regions). The silane molecule used can be a 3-mercaptopropyl trimethoxysilane or the like (e.g., when DNA has a thiol terminal so covalent bond can be formed between DNA and silane molecules). Additionally, or alternatively, the bottom of nano-well surfaces can be coated with an acrylate polymer that permits DNA covalent attachment (e.g., as described in U.S. Patent Pub. No. 2016/0122816A1 (Novel Polymers and DNA Copolymer Coatings), the entirety of which is incorporated herein by reference).

Some embodiments of the present disclosure include a method of using microfluidic devices that include patterned nano-wells on an etched channel floor surface for gene sequencing applications. In some embodiments, a primer DNA sequence (e.g., dA30 or dT30) is covalently or otherwise attached to the bottom regions of metal oxide nano-wells of the substrate, followed by capturing of single-stranded DNA molecules obtained from a sample, clustering generation, and sequencing. The single-stranded DNA molecules obtained from a sample can contain a sequence that is complementary to the primer DNA sequence. The clustering can be performed using bridge amplification, or exclusion amplification, or template walking approaches. The sequencing can be achieved through sequencing by synthesis, or ligation, or single-molecule real-time imaging.

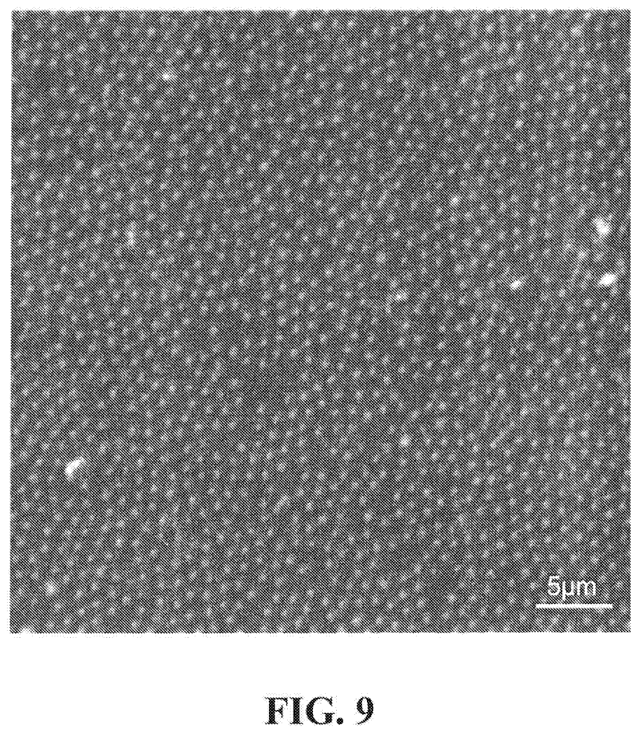

FIG. 9 shows a fluorescence microscopic image of Cy3-dT30 after being hybridized to the dA30 array. Formation of the dA30 array was achieved through covalent coupling, via a bifunctional linker BS3, of the 5′-amine terminal of the dA30 molecules to the amine groups of the silane coating within the bottom surfaces of the nano-well array formed using the above-described nanosphere lithography. Here, an Al₂O₃ nano-well array was first formed on the channel floor surfaces of a 1×3-inch 8-channel substrate using the nanosphere lithography approach (1 μm polystyrene beads after a 5-minute oxygen plasma treatment were used as the template). Afterwards, the substrate was subject to oxygen plasma treatment for 10 minutes at 100 watts, and was then coated with 5 mg/ml poly(vinylphosphonic acid) (Sigma Aldrich) in water at 90° C. for 5 min. The substrate was then rinsed 3 times in deionized water and one time in 100% ethanol. After nitrogen drying and annealing in an oven at 90° C. for 10 minutes, the substrate was then incubated with 2% 3-aminopropyltriethoxysilane in 95% ethanol/5% water, pH ˜5 at room temperature for 10 minutes, followed by rinsing four times in 100% ethanol with a nitrogen dry. This two-step coating resulted in a 3-aminopropyltriethoxysilane coating on the bottom surfaces of nano-wells formed, and a poly(vinylphosphonic acid) coating on the side wall surfaces of nano-wells formed, the latter of which is resistant to binding with DNA, proteins and/or nucleotides. The coated substrate was then reacted with 100 μM 5′-amine-C6-dA30 in the presence of 200 μM BS3 in 1×PBS for one hour at room temperature, followed by rinsing with deionized water and a nitrogen dry. As the result, dA30 is specifically attached to the bottom surfaces of nano-wells formed. Finally, the dA30 coated substrate was hybridized with 1 μM Cy3-dT30 in 1×PBS for 30 minutes, rinsed, nitrogen dried and examined using confocal fluorescence microscopy. Results showed that there were dT30 hybridization fluorescence signals at all nano-wells.

Furthermore, the 8-channel substrate also included a chromium-patterned coating at the top end surfaces of the substrate, beside the channels. After Al₂O₃ nano-well formation on the entire interior surface of the substrate, the substrate was found to bond with another bottom glass substrate (1×3 inch) using laser assisted bonding at room temperature. The resulting microfluidic device was found to have a hermetic seal and to enable DNA sequencing based on template walking and sequencing by synthesis. Together, these results suggest that the dA30-functionalized microfluidic devices supports massively parallel DNA sequencing.

As disclosed herein, the patterned microfluidic devices can be made of thin and/or channeled substrates, permitting better quality of optical fluorescence imaging of both the top and bottom surfaces of a microfluidic channel due to limited working distance of objectives used for high-resolution imaging. Conventional photolithography and nanoimprinting are typically applicable to patterning on relatively thick flat substrates (e.g., 0.5 mm, 0.7 mm, 1 mm, 1.1 mm). For thinner substrates (e.g., 0.1 mm, 0.2 mm, 0.3 mm), a carrier is typically required for patterning processes. Use of a carrier can complicate the manufacturing process and add cost. In contrast, nanosphere lithography can deal with thinner substrates, or substrates with variable thickness (e.g., channeled substrates).

The patterned microfluidic devices of the present disclosure enable DNA sequencing analysis with high signal-to-background ratios, since the interstitial regions (e.g., between adjacent nano-wells) can be coated with a material resistant to binding with DNA, proteins, and/or nucleotides, and the bottom surface of nano-wells can be coated with a material that promotes binding with DNA, proteins, and/or nucleotides. Additionally, the disclosed processes for manufacturing patterned microfluidic devices can be performed at lower cost compared to conventional photolithography or nanoimprinting techniques, since such processes can be performed without sophisticated and expensive equipment for creating nano-patterning. Furthermore, the disclosed manufacturing processes can be scalable, flexible, and have high throughput. The disclosed processes can be also flexible in terms of substrates, such as flat or channeled substrates, round or square wafers, small (e.g., slides) or large (e.g., wafers, glass sheet) substrates. The disclosed processes can be scalable, since they can be applied to large dimension substrates such as Gen 5 display glass panels. The disclosed processes can readily reach a throughput of several thousand wafers per hour.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosed embodiments. No language in the specification should be construed as indicating any non-claimed element as essential.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

1. A method of manufacturing a microfluidic device, the method comprising the steps of:
depositing a monolayer of beads in one or more channels of a first substrate;
reducing a size of the beads disposed on the first substrate;
depositing a film comprising at least one of a metal oxide or a silicon dioxide onto the first substrate over the monolayer of beads;
removing the beads from the first substrate to form an array of nano-wells in the film, the first substrate exposed at bottoms of the nano-wells; and
bonding a second substrate to the first substrate to enclose the array of nano-wells in a cavity between the first and second substrates.

2-9. (canceled)

10. The method of claim 1, comprising coating a bottom surface of one or more of the array of nano-wells with a first material that enables binding with at least one of DNA, proteins, or nucleotides.

11. The method of claim 10, wherein:
the bottom surface of the one or more nano-wells comprises an exposed portion of the first substrate comprising SiO₂ or glass; and
the first material comprises at least one of amine-terminated silane, epoxy-terminated silane, carboxylate-terminated silane, thiol-terminated silane, or a silane derivative comprising an unsaturated moiety.

12. The method of claim 10, wherein:
the bottom surface of the one or more nano-wells comprises an exposed portion of the first substrate comprising a metal oxide; and
the first material comprises at least one of amine-terminated organophosphate, epoxy-containing organophosphate, or carboxylate organophosphate.

13. The method of claim 1, further comprising bonding a DNA primer to the bottoms of one or more of the nano-wells.

14. A method of manufacturing a microfluidic device, the method comprising the steps of:
depositing a monolayer of polymer beads onto a first substrate;
depositing a film comprising a metal oxide or silicon dioxide onto the first substrate over the monolayer of polymer beads;
removing the polymer beads from the first substrate to form an array of nano-wells disposed in the film, wherein the first substrate is exposed at bottoms of the nano-wells; and
bonding a second substrate to the first substrate to enclose the array of nano-wells in a cavity between the first and second substrates.

15-18. (canceled)

19. The method of claim 14, comprising coating a bottom surface of one or more of the array of nano-wells with a first material that enables binding with DNA, proteins and/or nucleotides.

20. The method of claim 19, wherein:
the bottom surface of the one or more nano-wells comprises an exposed portion of the first substrate comprising SiO₂ or glass; and
the first material comprises at least one of amine-terminated silane, epoxy-terminated silane, carboxylate-terminated silane, thiol-terminated silane, or a silane derivative comprising an unsaturated moiety.

21. The method of claim 19, wherein:
the bottom surface of the one or more nano-wells comprises an exposed portion of the first substrate comprising a metal oxide; and
the first material comprises at least one of amine-terminated organophosphate, epoxy-containing organophosphate, or carboxylate organophosphate.

22. The method of claim 14, comprising bonding a DNA primer to the bottoms of one or more of the nano-wells.

23-25. (canceled)

26. The method of claim 14, wherein the depositing the monolayer of polymer beads onto the first substrate comprises depositing the polymer beads in one or more channels of the first substrate.

27. The method of claim 14, wherein the bonding the second substrate to the first substrate comprises bonding the first and second substrates using at least one of a glue, a UV-curable glue, a polymer tape, or a pressure-sensitive tape.

28. The method of claim 14, wherein the bonding the second substrate to the first substrate comprises bonding the first and second substrates using laser-assisted bonding, wherein a bonding layer comprising at least one of a metal or a metal oxide is disposed between the first and second substrates.

29. The method of claim 14, comprising imparting a negative charge to the polymer beads and a positive charge to the first substrate.

30. The method of claim 14, wherein a thickness of the film is from one nanometer to 500 nanometers.

31. The method of claim 14, wherein the film is transparent to light with wavelengths in a range from 450 nanometers to 750 nanometers.

32. A microfluidic device comprising:
a first substrate comprising a first patterned array of nano-wells on a first interior surface and a side wall comprising an end surface; and
a second substrate comprising a second interior surface and a peripheral surface portion;
wherein the end surface of the first substrate is bonded to the peripheral surface portion of the second substrate such that the first and second interior surfaces define a cavity within the bonded first and second substrates.

33. The microfluidic device of claim 32 wherein the second substrate comprises a second patterned array of nano-wells on the second interior surface.

34. The microfluidic device of claim 32, wherein the first patterned array of nano-wells or the second patterned array of nano-wells is disposed within one or more channels in the respective first or second interior surface.

35. The microfluidic device of claim 34, wherein a depth of the one or more channels is from 30 micrometers to 500 micrometers.

36-37. (canceled)
